(19) United States
(12) Patent Application Publication
(10) Pub. No.: US 2021/0252678 A1
(43) Pub. Date: Aug. 19, 2021

(54) Bracket Mounting Tool And Method Of Use

(71) Applicant: House of Atlas, LLC, Evanston, IL (US)

(72) Inventors: Jason Moss, Libertyville, IL (US); Alan Arthur Ford, Sturgis, MI (US)

(21) Appl. No.: 16/791,891

(22) Filed: Feb. 14, 2020

(51) Int. Cl. B25B 23/00; G01C 9/28

(52) U.S. Cl. CPC B25B 23/005; G01C 9/34; G01C 9/28

(57) ABSTRACT

There is provided a tool that makes more efficient and accurate mounting of brackets to a surface. The tool includes predefined locations for preinstalling fasteners used to hold a bracket at a wall or other structure. The tool also includes a level to ensure that fasteners mounted using the tool are positioned vertically with respect to one another. The tool also can be used to mount a second bracket at a same vertical height of a corresponding first bracket.

### FIELD

The disclosure relates to mounting support brackets and, more particularly, to tools used in the process of mounting supporting brackets.

### BACKGROUND

Many support brackets include holes for fasteners to mount the brackets to a wall. The holes are commonly aligned vertical so that when the holes are aligned vertical along a wall the bracket is aligned vertical. The alignment of the holes in the wall requires tools and writing instruments. For example, a level and a pencil are typically required to make sure the markings made on the wall for the fastener holes are aligned vertically. Then, one needs to use a tool, such as a powered driver or a manual screwdriver, to install the fasteners. It is desired to be able to reduce the number of tools required to properly install a bracket to simplify the process.

### BRIEF DESCRIPTION OF THE DRAWINGS

FIG. 1 is a front elevation view of a bracket mounting tool;

FIG. 2 is a side elevational view of the bracket mounting tool of FIG. 1;

FIG. 3 is a plan view of the bracket mounting tool of FIG. 1;

FIG. 4 is front elevation view of the bracket mounting tool of FIG. 1;

FIG. 5A-5D is sequence of steps in using the bracket mounting tool of FIG. 1 to preinstall fasteners in a wall; and

FIG. 6 is a side elevation view of a bracket that can be mounted on the preinstalled fasteners of FIG. 5D; and

FIG. 7 is a rear view of the bracket of FIG. 6.

### DETAILED DESCRIPTION

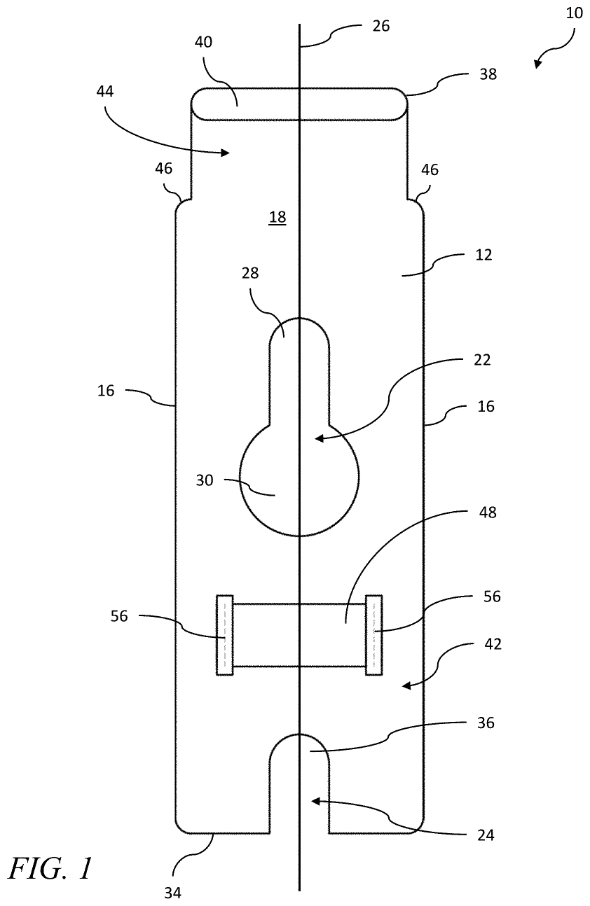

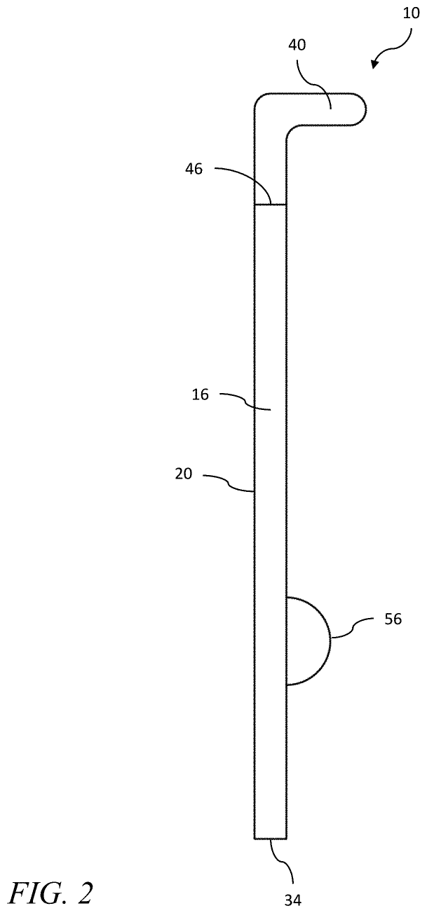

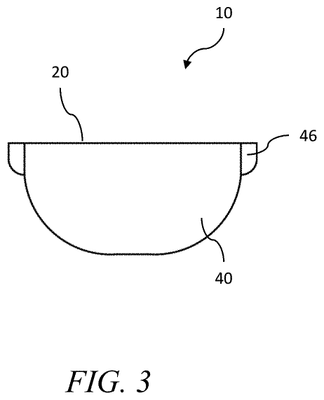

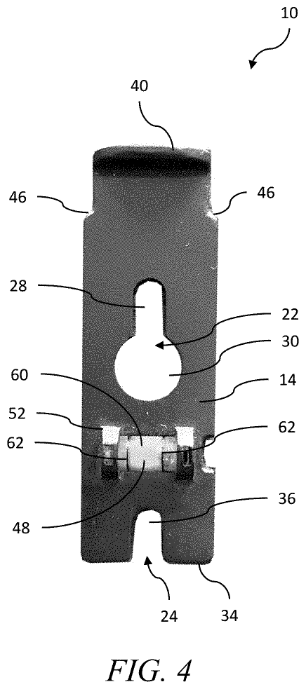

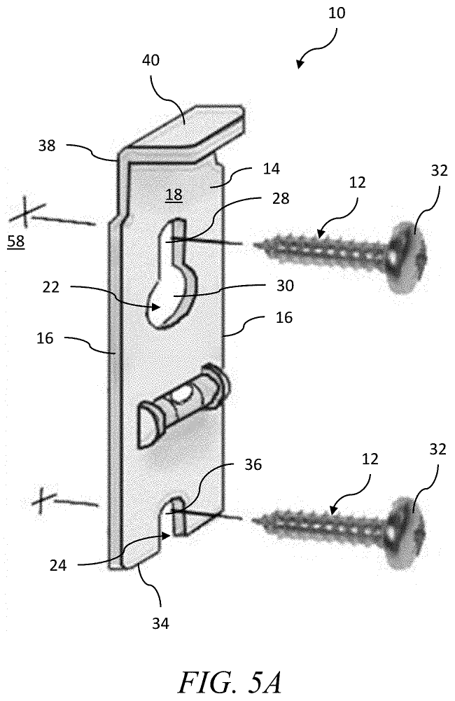

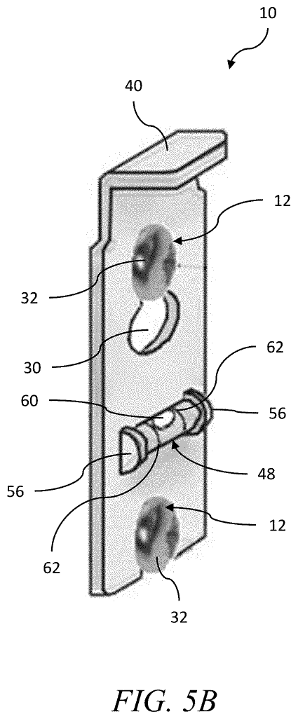

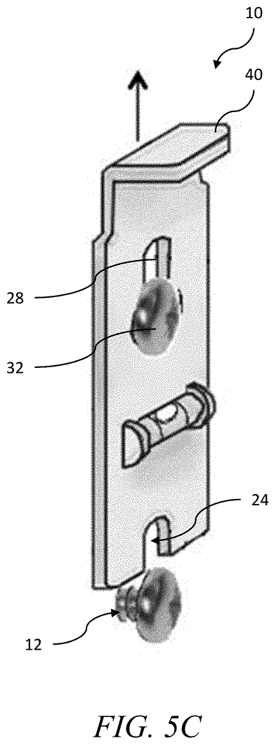

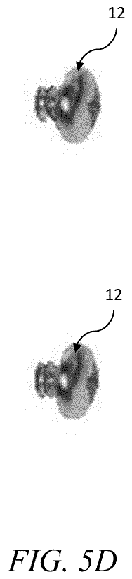

Referring to FIGS. 1-4, there is illustrated a bracket mounting tool 10 that can be used to replace a conventional level and writing utensil because the tool 10 combines the function of the two and eliminates the need for a writing utensil. The tool 10 can also have a thickness limiting the depth of insertion of fasteners 12 (FIG. 5B) to a thickness of a bracket that will be supported on the fasteners 12, which removes the potential for unnecessary threading and unthreading to set the depth of the fasteners 12, which may weaken the hold integrity between the fasteners and the wall material.

More specifically, the tool 10 includes a main body 14 that can be in the form of a rectangular plate with opposing linear edges 16, a flat front surface 18 and a flat back surface 20. Other shapes, including any polygonal shape, for the plate 10 are contemplated as well.

The body 14 defines an upper aperture 22 and a lower aperture 24 used to locate an insertion of position of the fasteners 12 into a wall. The apertures 22, 24 are preferably centered on a longitudinal centerline axis 26 of the body 14. The upper aperture 22 may include a keyway shape with a smaller upper portion 28 and a larger lower portion 30. The keyway shape enables a fastener 12 to be installed in the smaller upper portion 28, and after installation, the tool 10 can be slid upward until a head 32 of the fastener 12 is aligned with the larger portion and removed from the fastener 12 by passing the head 32 of the fastener 12 through the larger lower portion 30.

The lower aperture 24 may be located along a lower edge 34 of the body 14 and take the form of an open-ended slot where an opening is along the lower edge 34. A fastener 12 may be installed in an upper portion 36 of the lower aperture 24, and then, the tool 10 can be slid upward to slide the tool 10 off the fastener 12. This occurs at the same time the tool 10 is being removed from the upper fastener 12. Thus, the vertical length of the apertures 22, 24 are coordinated so that when the head 34 of the upper fastener 12 is at the larger portion 30 of the upper aperture 22, the fastener 12 at the lower aperture 24 is out of the lower aperture 24. The spacing between the apertures 22, 24 is coordinated to match spacing between mounting holes in a bracket.

The number of apertures in the body for fasteners can be increased to accommodate brackets using more fasteners and can be spaced apart from one another at different distances to accommodate a bracket's spacing of its mounting holes. Also, additional apertures can be located off the longitudinal centerline axis. Also, the tool can be scaled up or down in size.

A top end 38 of the body 14 can include a handle or a tab 40 for moving the tool 10. The handle 40 can be used to move the tool 10 up and off the installed fasteners 12 during use. The handle 40 can be a single piece with the body 10 or it can be a separate component that is glued, welded or attached in any other conventional manner to the body 10. The handle 40 can be disposed at any angle relative to the body 10 that enables a user to easily grip it without interference by the body 14 or a wall. A preferred angle is 90 degrees. If the handle 40 is a single piece construction with the body 10, it can be bent from the same material if the material is metal or it can be made from the same mold if it is plastic.

The body 14 may have a lower portion 42 and an upper portion 44. The lower portion 42 may include the apertures 22, 24, and the upper portion 44 may be attached to the handle 40. The lower portion 42 may have a width that is greater than a width of the upper portion 44. A shoulder 46 at each side edge 16 may transition the lower portion 42 to the upper portion 44. The shoulder 46 may be include a rounded edge.

A level 48 is mounted to the body 14 to enable a user to ensure that the apertures 22, 24 are aligned vertically. The level 48 is a conventional bubble type level, but also could be any type of level, including a conventional digital level. The level 48 is mounted perpendicular to the longitudinal centerline axis 26 of the body 14. The level 48 has a transparent cylindrical body 50 with each end mounted to the body 14. The body 14 can include an elongated slot 52 and two semicircular recesses 56. The cylindrical body 50 can be elastic so that it can be snapped into the slot 52 and the recess 56 with a snap fit to hold attach it to the body 14. Alternatively, the elongated slot 52 and the recesses 56 can be large enough to receive the level 48 without elastically deforming the level 48, and then, the level 48 can be glued into the elongated slot 52 and the recesses 56.

The following table identifies dimensions of an exemplary and non-limiting tool.

| | Measurement |
|---|---|
| | (inches unless |
| Measurement Description | otherwise indicated) |
| Body length | 2.35 |
| Body width (upper portion/lower portion) | 0.68/0.78 |
| Body thickness | 0.10 |
| Center of upper portion of lower aperture | 0.22 |
| from the lower edge of the body | |
| Center of lower portion of upper aperture | 1.13 |
| from the lower edge of the body | |
| Center of upper portion of upper aperture | 1.54 |
| from the lower edge of the body | |
| Radius of curvature of top of lower aperture | 0.09 |
| Radius of curvature of lower portion of | 0.19 |
| upper aperture | |
| Radius of curvature of top of upper portion | 0.09 |
| of upper aperture | |
| Length of lower portion of body | 2.00 |
| Length of upper portion of body | 0.35 |
| Length of handle | 0.35 |
| Length of bubble level | 12 millimeters |
| Diameter of bubble level | 5 millimeters |
| Centerline of bubble level from bottom end of | 0.63 |
| body | |

FIGS. 5A-5D illustrate a method of using the bracket mounting tool 10. The tool 10 is placed on a wall 58 at a location were a bracket is to be mounted. While holding the tool 10 against the wall 58, the tool 10 is oriented so that a bubble 60 in the level 48 is positioned between lines 62 on the level 48 to ensure that the apertures 22, 24 are aligned vertically. Then, also while holding the tool 10, fasteners 12 are installed into the wall 58 through the upper portions of the apertures 22, 24 until the head 32 of the fasteners 12 is near or at the body 14 of the tool 10. The tool 10 is then moved upward to place the head 32 of the upper fastener 12 at the larger portion 30 of the upper aperture 22 and the lower aperture 24 is clear of the head 32 of the lower fastener 12. A user would not want the fasteners 12 too tight against the body 14 so that the tool 10 is easy to move and does not damage the wall 58. The handle 40 can assist in moving the tool 10 upward. Finally, the tool 10 is pulled away from the wall 58 with the head 32 of the upper fastener 12 passing through the lower portion 30 of the upper aperture 22, and a bracket with similar aperture spacing is installed on the fasteners. Spacing of the apertures 22, 24 is coordinated to match the spacing of mounting holes of a bracket.

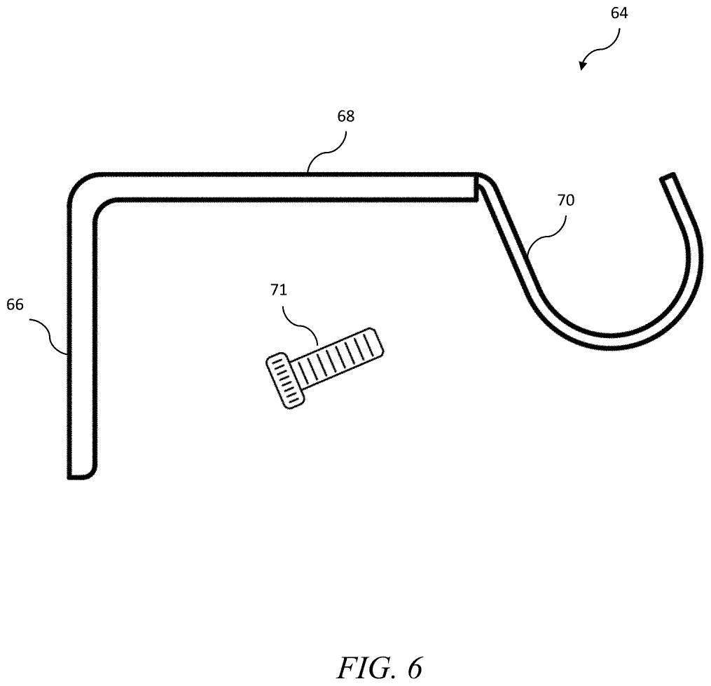

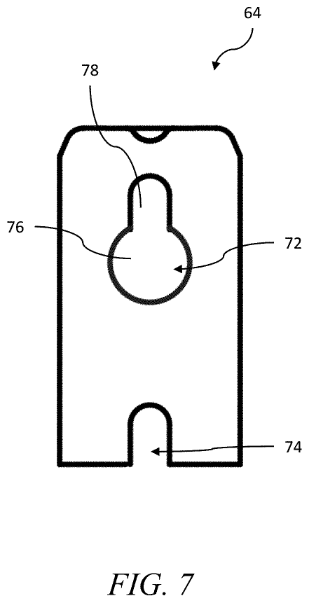

One example of a bracket 64 that can be installed with the assistance of the tool 10 is illustrated in FIGS. 6 and 7. The bracket 64 includes a mounting arm 66, a support arm 68, and a cradle 70 supported by the support arm 63. A set screw 71 can be used to retain a rod in the cradle 70. The mounting arm 66 includes an upper aperture 72 and a lower aperture 74 that preferably match the size and spacing of the apertures 22, 24 of the tool 10. The upper aperture 72 includes a larger opening portion 76 to receive the head 32 of the fastener 12, and a smaller opening portion 78 to lock onto the head 32 of the fastener 12. The lower aperture 74 is configured as an open-ended slot to receive the fastener 12 and lock onto the fastener 12. To mount the bracket 64, the larger opening portion 76 of the upper aperture 72 is placed over and receives the head 32 of one of the fasteners 12 and the lower aperture 74 is aligned with the other of the fasteners 12. Then, the bracket 64 is moved downward on the fasteners 12 so that the mounting arm 66 is sandwiched between the heads 32 of the fasteners 12. Next, the fasteners 12 can be tightened so that the bracket 64 does not unintentionally release from the fasteners 12.

A rod is supported by the cradles of at least two brackets, for example, at least two of the brackets 64 described above. The brackets are spaced apart from one another and positioned at the same vertical height so that the rod is level. The tool 10 can be used to assist in locating the vertical height of the second bracket without having to measure the vertical height. For instance, with the tool 10 mounted on the fasteners for the first bracket, a straight edge, such as a yardstick or a level, can be placed into engagement with the lower edge 34 of the tool 10. Since the lower edge 34 is straight and perpendicular to true vertical alignment, any straight edge placed along it can be used to extrapolate laterally to mark a location at the same vertical height. Once the vertical height is matched with the proper lateral spacing, the tool can be moved over to the new location, the lower edge 34 of the tool 10 can be placed along the vertical height marking for the location of the second bracket and, then, used as discussed above to set the fasteners for the second bracket.

The above discussion has referred to the tool 10 being used in the orientation with the handle 40 at the top. However, the tool 10 can used upside down. That is, in an orientation that is 180 degrees from that shown in the figures. When used upside down, the removal of the tool 10 from the installed fasteners 12 is done by moving the tool 10 down to clear the heads 32 of the fasteners 12 from the body 14.

The tool can be molded from plastic or metal. Alternatively, it can be stamped from metal with the handle being bent. The level can be attached as indicated above.

The matter set forth in the foregoing description and accompanying drawings is offered by way of illustration only and not as a limitation. While particular embodiments have been shown and described, it will be apparent to those skilled in the art that modifications may be made without departing from the broader aspects of the technological contribution. The actual scope of the protection sought is intended to be defined in the following claims.

What is claimed is:

1. A tool for installing fasteners to mount a bracket:
an elongated body having a centerline axis in an elongated direction of the body, defining at least two fastener guide apertures aligned parallel to the centerline axis, and spacing between at least two fastener guide apertures matching spacing between mounting apertures of a bracket; and
a level being permanently fixed to the body and perpendicular to the centerline axis.

2. The tool of claim 1 wherein the body has at least two longitudinal guide edges parallel to the centerline axis.

3. The tool of claim 1 wherein the at least two fastener guide apertures being aligned along the centerline axis.

4. The tool of claim 1 wherein the at least two fastener guide apertures include a first portion contiguous with a second portion, and the first portion being smaller than the second portion.

5. The tool of claim 4 wherein at least one of the at least two fastener guide apertures includes a slot at a bottom edge of the body.

6. The tool of claim 1 wherein the body includes at least two recesses used in affixing the level to the body.

7. The tool of claim 1 further comprising a handle associated with the body to move the body between a first position for installing one or more fasteners and a second position for removing the body from the installed one or more fasteners, and the handle being disposed out of a plane of the body at an angle greater than zero with respect to the body.

8. The tool of claim 1 wherein a bottom edge of the body is perpendicular to the centerline axis.

9. A method for installing fasteners comprising the steps of:
providing a tool comprising an elongated body having a centerline axis in an elongated direction of the body, defining at least two fastener guide apertures aligned parallel to the centerline axis, and spacing between at least two fastener guide apertures matching spacing between mounting apertures of a bracket, and a level being permanently fixed to the body and perpendicular to the centerline axis.
placing the tool in a desired location on a surface;
determining whether the centerline axis is vertical using the level;
adjusting the tool using the level to align the centerline axis vertical;
inserting one or more fasteners into the surface using the plurality of fastener guide apertures;
moving the body over the surface and along the centerline axis from a first position for inserting the one or more fastener to a second position permitting removal of the tool from one or more installed fasteners and the surface; and
removing the body from the one or more installed fasteners and the surface.

10. The method of claim 8 further comprising the steps of providing a tool with a handle associated with the body to move the body, the handle being disposed out of a plane of the body at an angle greater than zero with respect to the body, and using the handle to move the body over the surface and along the centerline axis from a first position for inserting in the one or more fasteners to a second position permitting removal of the tool from one or more installed fasteners and the surface.

11. The method of claim 8 wherein the at least two fastener guide apertures are aligned along the centerline axis.

12. The method of claim 8 wherein at least one of the plurality of fastener guide apertures includes a first portion and a second portion, and the first portion being smaller than the second portion, and further comprising the step of moving the body over the surface along the centerline axis from a first position where an installed screw extends through the first portion to a second position where the installed screw extends through the second portion.

13. The method of claim 8 wherein at least one of the at least two fastener guide apertures includes a slot, and further comprising the step of moving the body over the surface along the centerline axis from a first position where an installed screw extends through the slot to a second position where the installed screw is removed from the slot.

14. The method of claim 8 wherein the body of the tool includes a bottom edge that is perpendicular to the centerline axis and further comprising the step of using the bottom edge of the tool to locate a vertical height on the surface to move the tool to a second location.
